(19) United States
(12) Patent Application Publication
(10) Pub. No.: US 2017/0131851 A1
(43) Pub. Date: May 11, 2017

(54) INTEGRATED MEDIA DISPLAY AND CONTENT INTEGRATION SYSTEM

(71) Applicant: FLX Media, LLC, Fultondale, AL (US)

(72) Inventor: John Thompson, Chattanooga, TN (US)

(73) Assignee: FLX Media, LLC, Fultondale, AL (US)

(21) Appl. No.: 15/348,375

(22) Filed: Nov. 10, 2016

Related U.S. Application Data
(60) Provisional application No. 62/253,489, filed on Nov. 10, 2015.

(51) Int. Cl. G06F 3/0481; G06Q 30/06; G06F 3/0484

(52) U.S. Cl. CPC G06F 3/0481; G06F 3/04842; G06Q 30/0643

(57) ABSTRACT

An interactive content server associates interactive content with source media. A user requests the source media and an interactive content package is also provided to the user. This interactive content package provides information to enable the display of an interactive call within the source media, such as information relating to the content, location, time period, and effects for the interactive call. The interactive call is processed by a media wrapper, which interacts with a media program to control display of the interactive content within the media program. The interactive call is displayed within the source media, and when the user selects the interactive call, the interactive content is displayed to the user.

### BACKGROUND

As consumers access more information such as video, music, augmented reality content, and virtual reality content over networks such as local networks and the internet, advertising is moving from broadcasted content to this content that is accessed over networks. Rather than having a limited number of sources that provide content (e.g., broadcasters, radio stations, newspapers, or even a limited set of internet media sources) content creators and advertisers have an increasingly large number of sources that are available to users over any device that is accessible via a network. As the available content and media sources have become fragmented, so to have the mediums through which content is accessed. For example video content may be run through internet browsers, integrated media programs of “smart devices,” a variety of media players, and on numerous types of operating systems. Consumers are able to skip or forward through content that is related to the media, and in a fragmented market with fragmented technologies, it is difficult to create and distribute additional content that engages users and that functions properly in multiple different environments.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 depicts an illustrative diagram of interactive content integration system in accordance with some embodiments of the present disclosure;

FIG. 2 depicts an illustrative diagram of an interactive content server in accordance with some embodiments of the present disclosure;

FIGS. 3A-3B illustrate exemplary non-limiting implementations of a graphical user interface for content provider interactions with an interactive content server in accordance with some embodiments of the present disclosure;

FIGS. 4A-4B illustrate additional exemplary non-limiting implementations of a graphical user interface for a user of an interactive content server in accordance with some embodiments of the present disclosure;

FIG. 5 depicts an illustrative diagram of an end user device in accordance with some embodiments of the present disclosure;

FIG. 6 illustrates non-limiting implementations of a graphical user interface at an end user device in accordance with some embodiments of the present disclosure;

FIGS. 7A-7C illustrate exemplary non-limiting implementations of a graphical user interface at an end user device after a selection of interactive content by a user in accordance with some embodiments of the present disclosure;

FIGS. 8A-8B illustrate additional exemplary non-limiting implementations of a graphical user interface at a user device after a selection of interactive content by a user in accordance with some embodiments of the present disclosure;

FIG. 9 depicts exemplary steps for creating integrated media content in accordance with some embodiments of the present disclosure;

FIG. 10 depicts exemplary steps for displaying integrated media content in accordance with some embodiments of the present disclosure; and

FIG. 11 illustrates exemplary non-limiting implementations of a graphical user interface for an interactive content integration system in an in-store retail application in accordance with some embodiments of the present disclosure.

### DETAILED DESCRIPTION

A framework is provided for the creation, delivery, and use of interactive content that is integrated with an underlying media source when accessed on an interactive display of a user device. In an embodiment, the interactive content with media content may be delivered to a user such as by over the top (“OTT”) media that is delivered and via a network such as the internet and accessible to the consumer at a variety of user devices such as smart phones, tablets, wearable devices, televisions, computers, gaming consoles, set-top boxes, virtual reality devices, augmented reality devices, and other connected devices such connected internet of things (“IoT”) devices and appliances. These devices may provide a variety of interfaces for viewing and interacting with the source media and interactive content, for example, based on the various user interface options (e.g., mouse, remote control, keyboard, touch screen, motion sensing, time-of-flight sensing, integrated cameras, etc.) that are available on the device as well as options of media software running (e.g., web browsers, media players, applications, operating systems, etc.) at the device.

A content provider may access an interactive content integration system in order to control the operation, integration, and display of content such as media content. Source media may correspond to a core source media that will be provided to a user for viewing, for example, in response to a user request via a user device. The content provider may select source media to be provided to a user, as well as interactive content that is to be integrated with the source media for display at the user device. The content provider may provide settings for the interactive content that may include information such as the form in which the interactive content will take (e.g., as an overlay of the source media, at certain locations relative to the source media, at certain times, in a manner to associate with certain objects within the source media, icons, symbols, text, etc.), information about when and how to provide the interactive content (e.g., associated with different platforms and programs from which the source media may be accessed), content of responsive interactive content (e.g., additional media to be provided in response to user interaction with the integrated interactive content), and streamlining of additional responses in response to user interaction with the interactive content (e.g., direct interaction with content provider systems, such as user information, customer data, etc.).

A user may attempt to access media such as the source media, and the request (e.g., via a communication network such as the internet, cellular network, mesh network, etc.) may result in the source media being provided to the user at a user device. In some embodiments, the request may be handled directly by the content provider, which may access an interactive content package that has been created and is stored internally with the content provider or may be accessed remotely. In some embodiments, a request may be routed to a third party (e.g., the provider of an interactive content server hosting the interactive content integration system) for integration of source media with the interactive content package. In some embodiments, the source media may initially be provided by any suitable source (e.g., content provider, interactive content server, source media server) such that a component of the user device (e.g., a media player, set top box, or application for viewing source media with integrated content) receiving the source media acquires the interactive content package such as by requesting the content from a content provider or interactive content server.

The interactive content package may include a variety of information for the integration of the interactive content with the source media, such as information that determines how, when, and where the interactive content is displayed with the source media, responsive interactive content or links, in response to user selections of interactive content, other actions to perform in response to selections (e.g., launching of other applications, interactions with other accounts or devices), other suitable information related to the display and interaction with interactive content, and suitable combinations thereof. This information may be processed by a media wrapper, which may be a component of program that will display the source media (e.g., a media program such as a media player), may be a plug-in to a media program, or may integrate with the media program in other suitable manners. In this way, the media wrapper may be integrated onto a user device such as a video player, audio player, or set-top box, and may operate with any existing media platform.

The media wrapper may process the interactive content package in order to identify interactive content and information about the display and response to the interactive content. Based on this information, the interactive content may then be displayed with the source media (e.g., within a media application, an internet browser, or a media player), users may interact with the interactive content, additional responsive media may be launched or provided based on those interactions, and other actions may be taken in some instances. Once the user has completed interaction with certain interactive content, source media may resume playing with interactive content, and in some embodiments, aspects of the interactive content package may be updated based on the user interactions.

Information may also be collected based on the user interactions with the interactive content. In an exemplary embodiment of integration of a relevant customer information into the source media, the interactive content may relate to content referenced in the source media, and a user selection of the interactive content may provide information such as product overview videos that provide product features and benefits, how to use/install product videos produced to improve the user experience, access to special pricing and incentives, coupons or discounts which are uploaded by a content provider, buy now options allowing automatic connection to content provider on-line stores, access to product ratings and reviews, the ability to save the product to favorites for quick access later, other functionality, and suitable combinations thereof. Based on the user's interactions with this product and customer, information may be returned to the content provider or interactive content server for analysis of customer information and the effectiveness of the interactive content (e.g., how long a user plays an instructional video, interaction with instructional videos, overall interaction with interactive content, effectiveness of different display methods at different times, etc.).

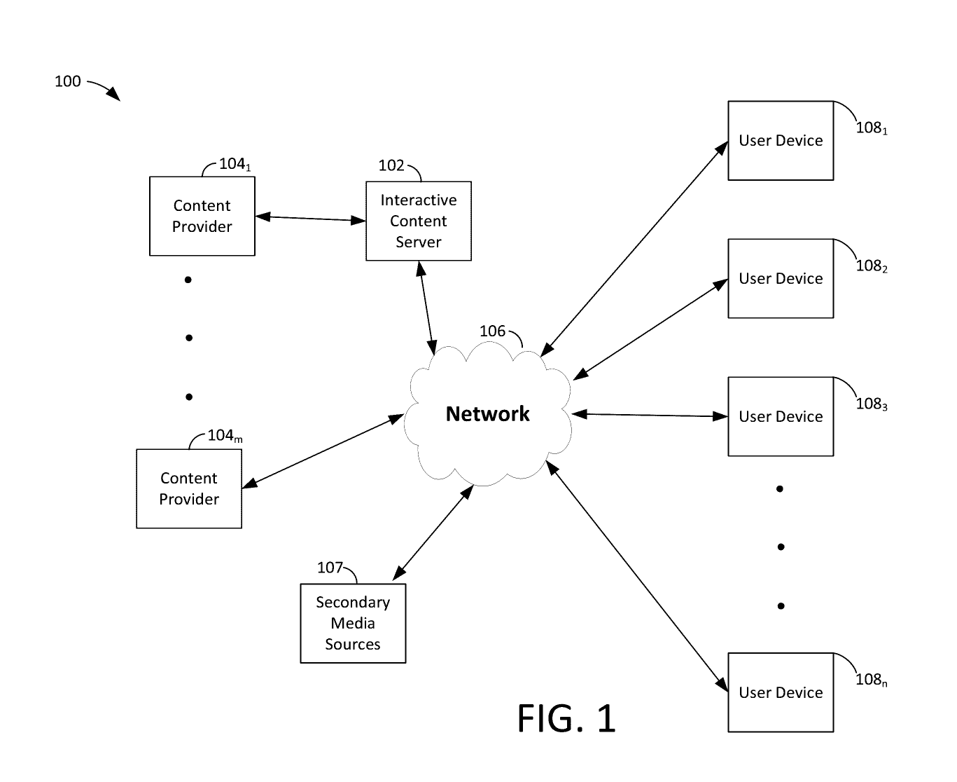

FIG. 1 depicts an illustrative diagram of interactive content integration system 100 in accordance with some embodiments of the present disclosure. Although it will be understood that an interactive content integration system 100 may be implemented in other suitable manners, in one embodiment, interactive content integration system 100 may include interactive content server 102, a plurality of content providers 104, a network 106, secondary media sources 107, and a plurality of end user devices 108. Although each of these components may be described as performing certain functionality in certain embodiments described herein, it will be understood that certain operations described herein (e.g., providing or accessing source media, providing or accessing interactive content, creating or accessing an interactive content package, integrating the interactive content package with the source media, providing responsive media, etc.) may be distributed differently about the components and may be performed at other components (e.g., server entities).

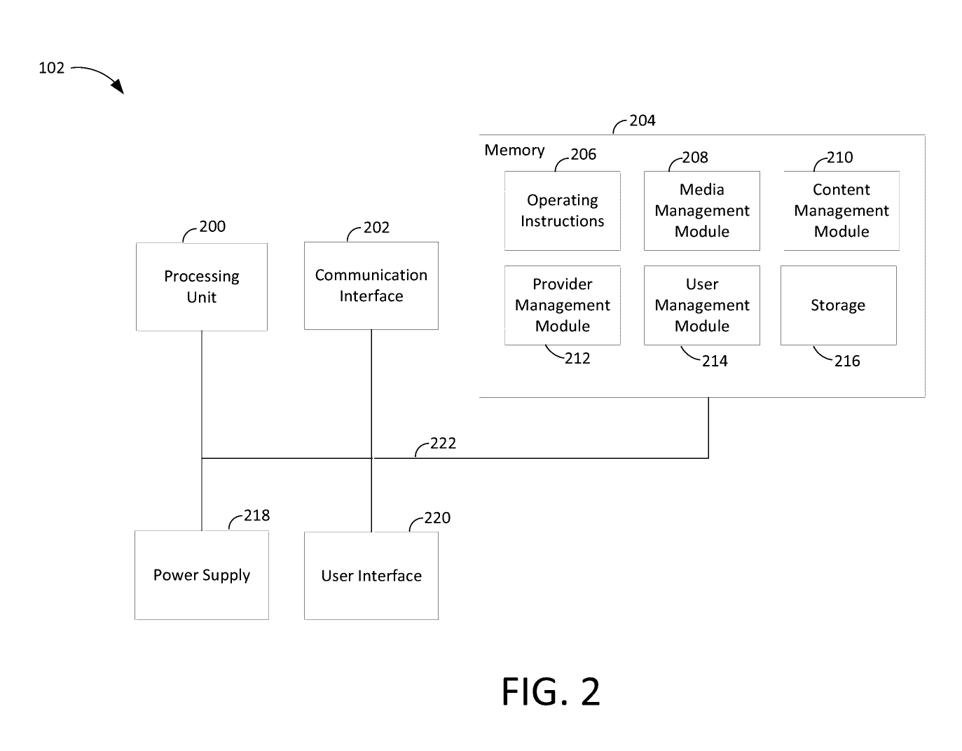

Interactive content server 102 may be a computing device, such as a general hardware platform server configured to support mobile applications, software programs, and the like executed on content provider 104 and/or end user device 108. Interactive content server 102 may include one or more processors executing code stored on a computer readable medium as well as databases storing information relating to various content associations (e.g., for source media and interactive content) for different content providers that are participating in the interactive content integration system 100. In embodiments, interactive content server 102 may include a processing device, a communication interface, a user interface and a memory device, as described more fully in FIG. 2.

Physical computing devices may reside with various content providers and users and may be deployed in a system in which content providers and users may in some instances be located remotely from the interactive content server 104, for example, in a cloud computing or similar network environment in which different devices and device types may access common or shared computing resources that are available over a data network such as the internet or cellular networks. An exemplary cloud model may utilize a variety of network resources (e.g., on-demand self-service, broad network access, resource pooling, rapid elasticity, measured service, etc.) and operational models (e.g., Software as a Service (“SaaS”), Platform as a Service (“PaaS”), Infrastructure as a Service (“IaaS”)).

In some embodiments, interactive content server 102 may generate, store, update, manage and distribute interactive content based on input and requests from one or more content providers 104 and/or end user devices 108, for example, via a public or dedicated communication network (e.g., the internet). In an embodiment, interactive content server may provide different levels of access to content providers to manage interactive content (e.g., interactive content insertion, interactive content appearance, interactive content timing, responsive media, targeting of interactive content, interactive content functionality on different platforms, etc., as described herein) to be integrated with source media. In an embodiment, interactive content server 102 processes interactive content and source content, any portion of which may originate with the content provider 104, interactive content server 102, secondary media sources 107, or other content and media sources.

Interactive content server 102 may provide a platform (e.g., via software applications installed at a content provider 104 or accessible from interactive content server 102 over the network 106) for the content provider 104 to access and modify a variety of information such as libraries of source media, libraries of interactive content, libraries of responsive media or actions, as well as information that relating to the content provider and users. For example, in an exemplary embodiment relating to a retailer providing interactive product content to a customer over source media (e.g., overlaying an interactive content or icon over a product), the interactive content server may host (or in some embodiments, may access from a content provider) product and consumer information such as product overviews, responsive media such as how to use/install product videos, access to product incentives, access to product reviews, etc. The user may access the interactive content page on an end user device 108, such as a smart phone, tablet computer, laptop computer, desktop computer, wearable computer, personal data assistant, or similar devices including suitable hardware and software (e.g., executing an integrated source media application) that is configured to process instructions and connect to network 106.

Network 106 may be a suitable network using wired and wireless communication networks or technologies, such as wired, wireless, terrestrial microwave, or satellite link networks such as the Internet, an intranet, a LAN, a WAN, a cellular network (e.g., LTE, HSPA, 3G, 4G and other cellular technologies) and/or another type of network. In some embodiments, network 106 may include a variety of communication resources that enable communication between end user devices 108, interactive content server 102, secondary contact servers, and content provider 104. According to some embodiments, the network 106 may comprise a number of different sub-networks and/or network components that are interconnected directly or indirectly. In some embodiments, components such as the interactive content server 102 and content provider 104 may be integrated into a single system or operate within a local area network.

Exemplary content providers 104 may provide different computing resources depending on the level of functionality or content that may be resident with the content provider 104. In some embodiments, integrated server resources may store user information, content provider information, interactive content, source content, secondary content, configuration information of interactive content packages, and other data and information as described herein. Depending on the content provider 104 resources and packages, in some embodiments, some or much of the processing to create interactive content packages and integrate them with source media may be performed on servers of the content provider 104, while in other embodiments the content provider may store or upload relevant information to the interactive content server with some or all of the processing to generate interactive content packages and integrate them with source media performed elsewhere (e.g., via an application or browser program). In some embodiments, wherever the content is stored a content provider 104 may access the information remotely from an application or program (e.g., in communication with the integrated content server 102) running on a computing device as a smart phone, tablet computer, laptop computer, smart watch, virtual or augmented reality device, desktop computer, wearable computer, personal data assistant, or similar devices that facilitate network communications and user interface functions by content providers.

Content providers 104 may access interactive content server 102 directly (e.g., a dedicated terminal) or via a communication channel such as the network 106 (e.g., the internet). In exemplary embodiments, content providers 104 may utilize a dedicated media application or Internet browser to access a user interface provided by interactive content server 102 and communicated via a suitable protocol (e.g., as encrypted data provided via a Hypertext Transfer Protocol (HTTP) interface).

In some embodiments, content for use in integrating the interactive content with the source media, such as source media, interactive content, and responsive content may be stored at one or more secondary media sources 107. A secondary media source may be any suitable computing device, and in some embodiments, may provide an application or other program for providing sources of media and other content that may be provided by third parties for use within interactive content integration system 100. For example, third parties may provide content that is searchable and compatible with the interactive content integration system 100, or in some embodiments, may be modified to be compatible (e.g., by the interactive content server 102). In this manner, content may be constantly identified and updated, and in some embodiments, a marketplace may be created for generation of source media and interactive content that may be utilized by content providers. For example, if the source media includes a product and a user decides to select interactive content related to that product, the responsive media such as an instructional video could have been accessed from a third party who created the video as a secondary content provider 107, with possible payment or other incentives (e.g., product credits, etc.) being to the secondary content provider.

Exemplary end user devices 108 may be suitable devices with user and communication interfaces, such as a smart phone, tablet computer, smart watch, laptop computer, virtual or augmented reality device, set-top box, desktop computer, wearable computer, personal data assistant, connected appliances, or similar devices that facilitate network communications and user interface functions by users, based on communications with interactive content server 102. Exemplary end user devices 108 may include memory, processing elements, communication devices (e.g., cellular, WiFi, Ethernet, etc.), a user interface (e.g., mouse, keyboard, touchscreen, voice, holographic display, etc.), and memory.

End user devices 108 may access interactive content server 102 directly (e.g., a dedicated terminal) or via a communication channel such as the internet. In exemplary embodiments, end user devices 108 may view source media integrated with the interactive content via a variety of programs such as proprietary programs, media player applications, browser applications, embedded software, or other similar programs, which may collectively be referred to herein as a media program. The source media and interactive content package may be accessed (e.g., from the internet) and the interactive content package may be integrated with the source media to create an integrated interactive media for display and use by the user. In different embodiments, the integration may be performed before or after being received at the end user device 108 or at the end user device 108 based on the media program, device capabilities, communication network speed, proximity to data sources, and other similar factors. Once integrated as the integrated interactive media, the user may view the source media and interact with the interactive content, view additional user interactions, view responsive media, and take other actions. In some embodiments, additional interactions may result in further integration of additional content based on communications with remoter servers such as the interactive content server 102 or based on additional conditional information provided in the original interactive content package.

FIG. 2 depicts an illustrative diagram of an interactive content server in accordance with some embodiments of the present disclosure. Although the interactive content server 102 is depicted as a single exemplary server, it will be understood that the operations and storage enabled by the processors and memory of the interactive content server 102 may be distributed over any suitable number of processor or memory devices in one or more servers and computing devices, and may be distributed (including over local and wide area networks) in any suitable manner. Although particular components are depicted in a particular arrangement in FIG. 2, it will be understood that interactive content server 102 may include additional components, one or more of the components depicted in FIG. 2 may not be included in interactive content server 102, and the components of interactive content server 102 may be rearranged in a variety of manners to implement the operations and functionality described herein. In an exemplary embodiment, interactive content server 102 includes a processing unit 200, a communication interface 202, a memory 204, an interface bus 222, a power supply 218, and a user interface 220.

Processing unit 200 may include hardware, software, memory, and circuitry as is necessary to perform and control the functions of interactive content server 102. Processing unit 200 may include one or more processors that may be configured and connected in a manner to perform the operations of interactive content server 102 based on instructions in any suitable number of memories and memory types. Processing unit 200 can be in communication with memory 204 (e.g., read only memory (ROM) and random access memory (RAM)), storing processor-executable instructions thereon that are executed by the processing unit 200 in order to control and perform the operations of the interactive content server 102. Memory may also store data related to the operation of the interactive content integration system, such as source media, interactive content, interactive content package data, icons, user data, content provider data, secondary media source information, and other suitable information described herein. By the processing unit 200 executing instructions and accessing stored data, the functionality of the interactive content integration system may be enabled.

In one embodiment, the processing unit 200 may be implemented as dual microprocessors, multi-core and other multiprocessor architectures running instructions for an operating system, programs, and applications based on processor-executable instructions that may be stored in memory 204. The processing unit 200 may execute the instructions of memory 204 to interact with and control one or more other components of the interactive content server 102. Although the processing unit 200 may communicate with other components of the interactive content server 102 in any suitable manner, in one embodiment the processing unit may utilize an interface bus 222. Interface bus 222 may include one or more communication buses such as I2C, SPI, USB, UART, and GPIO. In one embodiment, the processing unit 200 may execute instructions of the memory and based on those instructions may communicate with the other components of the interactive content server 102 via the communication buses of interface bus 222.

The memory 204 may include any suitable memory types or combination thereof as described herein, such as flash memory and RAM memory, for storing instructions and other data generated or received by interactive content server 102 and providing a working memory for the execution of the operating system, programs, and applications of the interactive content server 102. Memory 204 may refer to suitable tangible, non-transitory storage mediums for storing data, instructions, and other information. Examples of tangible (or non-transitory) storage medium include disks, thumb drives, and memory, etc., but does not include propagated signals. Tangible computer readable storage medium include volatile and non-volatile, removable and non-removable media, such as computer readable instructions, data structures, program modules or other data. Examples of such media include RAM, ROM, EPROM, EEPROM, SRAM, flash memory, disks or optical storage, magnetic storage, or any other non-transitory medium that stores information that is accessed by a processor or computing device.

In one embodiment, the memory 204 may include a plurality of sets of instructions, such as operating instructions 206, media management instructions 208, content management instructions 210, content provider management instructions 212, an user management instructions 214. In one embodiment, memory 204 may include one or more data stores, such as storage 216.

In an embodiment, operating instructions 206 may include instructions for the general operation of the interactive contact servers, such as for running generalized operating system operations, communication operations, user interface operations, anti-virus and encryption, and other suitable general operations of the server. For example, the operating instructions may provide instructions for communicating with content providers 104, secondary media sources 107, and user devices 108, e.g., to receive information relating to source media, interactive content, interactive content information, and other communication that is exchanged between the devices and servers as described herein. Operating instructions 206 may include instructions that when executed by processing unit 200 control these communications and provide for secure communication by implementing procedures such as TLS and SSL, and in some embodiments, encrypt and decrypt some or all of the information communicated with other via public or private key cryptography, or other similar methods.

Exemplary operating instruction 206 may also include instructions for managing media content that may be stored in storage 216. In embodiments as described herein, media content available in storage 216 may be created and updated based on information provided by content providers, for example, relating to interactive content or user generated information (e.g., user name, contact information, items viewed, actions taken, etc.) based on the user viewing the interactive content. Operating instructions may provide for management of storage 216 so that media content with associated interactive content is continuously stored and updated as described herein.

In some embodiments, media management instructions 208 may include instructions that allow a content provider 104 to manage the integration of interactive content with source media. In an embodiment, a content provider may wish to place one or more interactive calls (e.g., text, icon, picture, embedded video, etc.) within source media (e.g., video, audio, etc.), for example, to identify content that is relevant to the source media and/or user (e.g., information about a product that appears within a video clip depicting the product). The media management instructions 208 may include instructions that allow a content provider to set parameters for the interactive call, such as content, location, type of display (e.g., partially transparent, movement with item, flashing, changing of content), and conditions for display based on information such as previous user interaction with other interactive content during the same viewing session.

For example, in an embodiment, processing unit 200 may execute media management instructions 208 to provide a view of a library of source media (e.g., a full line of episodes related to a particular type of content) stored in storage 216 through a series of drop down selection options. In an embodiment, the content provider may select the source media for which the content provider wishes to place an interactive call. Media management instructions 208 may allow a content provider to specify the visual depiction of the interactive call (e.g., message, media content, opacity, and effects) and location information for the interactive call (e.g., by identification of a product that is tracked through source media, specifying a particular portion of the display of the source media, etc.).

In an embodiment, media management instructions 208 may allow the content provider to select particular times during which the interactive call appears within the source media, for example, when a product appears, based on particular times during which an associated product within the source media appears, or start and end times. The media management instructions 208 may generate the product interactive call message based upon automatic identification of the product within the source media using existing techniques such as pattern recognition or by automatic recognition of the position, size, or prominence of display of the product within the source media.

The media management instructions 208 may also enable a content provider 104 to select a response to selection of the interactive call, such as the particular interactive content that is provided in response to the selection (e.g., pop-up selections, responsive media, connections to applications or websites), manner of display (e.g., whether the source media is paused, location of display, length of display without additional interaction), additional actions to be taken in response to interaction with the interactive content, manner of delivery of the interactive content (e.g., with the interactive content package, from the interactive content server 102, from a content provider server 104), and other relevant information related to the interactive content as described herein.

Exemplary content management instructions 210 may include instructions that allow a content provider 104 to manage the content provider's interactive content contained within the interactive content integration system. In an exemplary embodiment, content management instructions may allow for secure access to the content provider's interactive content. For example, interactive content may be uploaded as well as information about and associations for the interactive content, such as stored information relating particular interactive content to source media content and user information. In an embodiment of a retail product, exemplary interactive content that may be entered or updated includes product name, product UPC/SKU, product overview video, how to/demo video, product images, product description, rebates/incentives, and other suitable interactive content, while other information may include known source media (e.g., videos depicting a product) that is associated with a product.

Merchant management instructions 212 may cause interactive content server 102 to provide a centralized platform to facilitate interactions between users and content providers in response to the selection of an interactive call or information within the interactive content. In an embodiment, content provider management instructions 212 may provide information to link (e.g., via a URL) a user to the content provider commerce site or information, which may include information such as consumer reviews, ratings, videos, and other suitable product related information. In an embodiment, content provider management instructions 212 may include instructions that allow content providers to manage incentives such as discounts, free shipping, rebates, etc. that are offered through the interactive content page. In an embodiment, content provider management instructions may allow content providers to establish budget caps and timelines for the incentives which the interactive content integration system may manage to assure the incentive is turned off at the appropriate time. In an embodiment, the content provider management instructions 212 may track the effectiveness of the incentive, allowing the content provider to adjust the incentive in an appropriate way to maximize user response to the product.

User management instructions 214 may cause interactive content server 102 to capture and compile a variety of data about products and users to be evaluated by content providers. In an embodiment, information captured and stored by user management instructions 214 may include but is not limited to user name, user contact information, product viewed, actions taken, incentive effectiveness for user, effectiveness of product video for user, or any other relevant user information related to a particular product that the user has viewed. In an embodiment, user information captured by user management instructions 214 may be stored and directly accessible via storage 216 of interactive content server 102. User management instructions 214 allows for real-time data aggregation relating to users, which allows content providers to remarket products to users.

Storage 216 may store information relating to various source media content, media content associations, content providers, and users that are participating in the interactive content integration system 100. Storage 216 may comprise a device for storing data (e.g., media data, media metadata, system information data, user data, network data, or any other appropriate data) and receiving data from and delivering data to software on interactive content integration system 100 (e.g., media management instructions 208, content management instructions 210, content provider management instructions 212, and user management instructions 214).

In an embodiment, content management instructions 210 may generate an interactive content package for source media, as described herein. Based on the information that is established by the interactions of the content provider 104 with the interactive content server 102, the interactive content package may be generated, and may include information necessary to provide the interactive content for integration with the source media, such as the actual interactive content or linking information therefor, responsive media, location information, timing information, and other user interaction information as described herein. In an embodiment, the interactive content package may be transmitted to a user along with source media. In another embodiment, a unique interactive content identifier may be provided to the interactive content server 102 from a user device 108 when the user device 108 receives the source media, and the content management instructions 210 may perform a query based on the interactive content identifier to identify a proper interactive content package to return to the user device 108, e.g., based on information and settings provided by the merchant and information of the user.

Communication interface 202 may include components and/or devices that allow interactive content server 104 to communicate with another device, such as content provider 104, secondary media source 207, and end user device 108, via a local or wide area connection. In embodiments, communication interface 202 may establish a secured connection with a content provider 104 and/or an end user device 108 and may be configured to receive information, such as interactive content associations to be processed, from content provider 104 or send information, such as source media and interactive content, to an end user device 108. Communication interface 202 may include one or more wireless transceivers for performing wireless communication and/or one or more communication ports for performing wired communication.

User interface 220 may provide various options that allow a content provider and/or user to interact with applications and programs running on interactive content server 102. In an embodiment, interactions may be performed via user interface 220 which may provide a device (e.g., a display, keyboard, mouse, etc.) with options for interacting with the interactive content integration system. In some embodiments, interactions may be performed remotely, for example, via communication interface 202. While one user interface 220 is shown, an example user interface 220 may include hardware and software for any suitable number of user interface items.

Interactive content server 102 may also include a power supply 218. Power supply 218 may supply a variety of voltages to the components of the server in accordance with the requirements of those components. Power supply 218 may include power conversion circuitry for converting AC power and/or generating a plurality of DC voltages for use by components of the server. In some embodiments, power supply 218 may include a backup system such as a battery backup, to avoid interruptions in service during power outages.

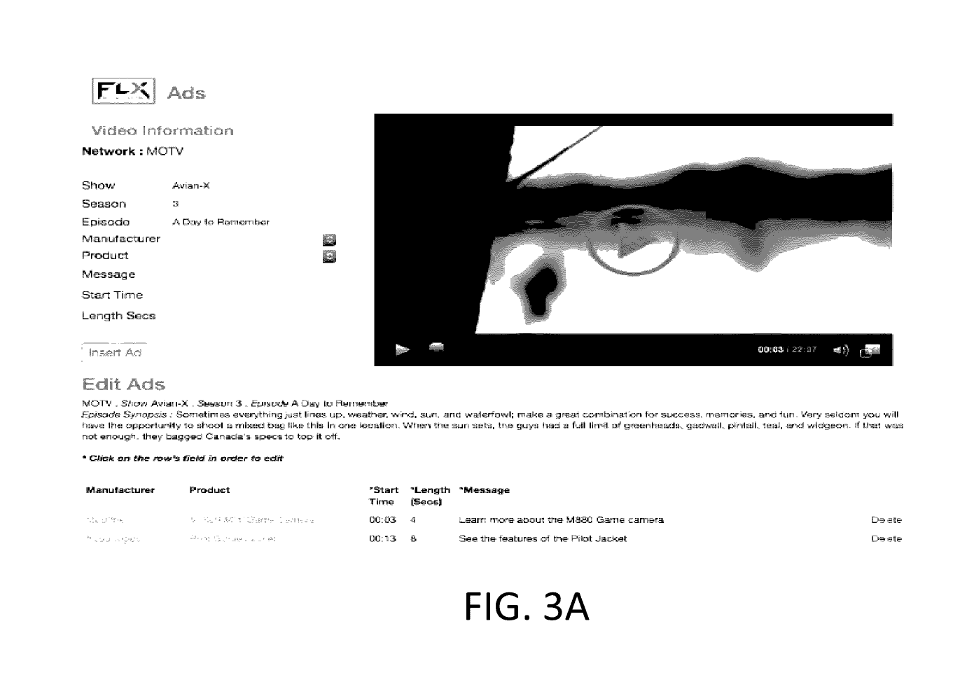

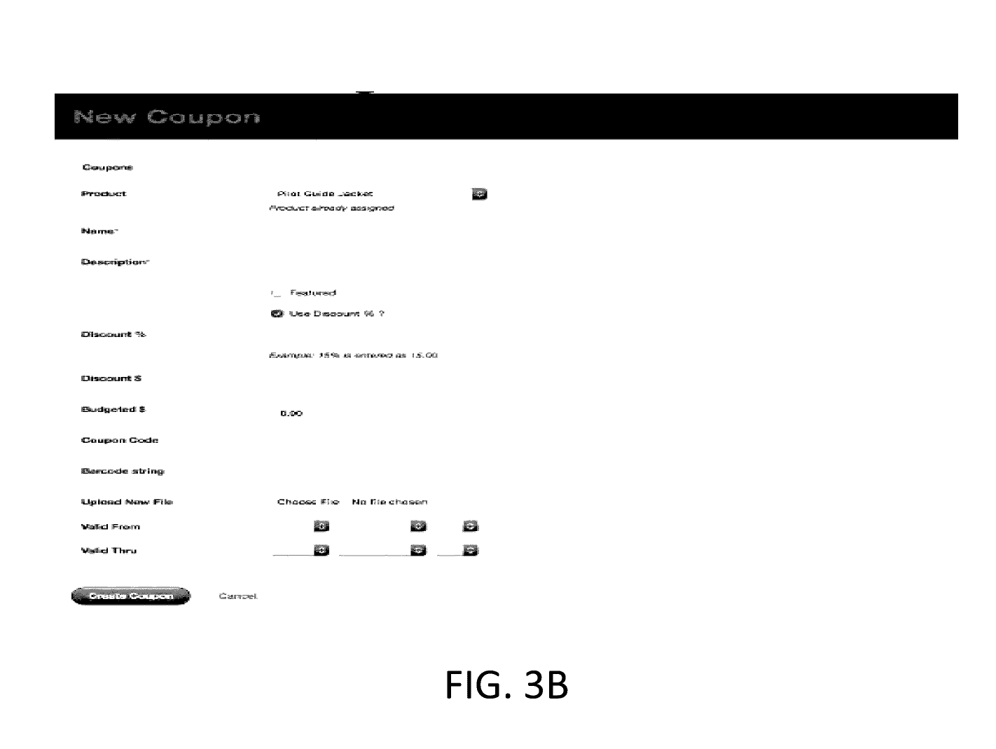

FIG. 3A illustrates exemplary non-limiting implementations of a graphical user interface for content provider interactions with an interactive content server in accordance with some embodiments of the present disclosure. In an embodiment, as shown in FIG. 3A, processing unit 200 of interactive content server 102 may execute instructions to manage the placement of interactive content relating to a product within a television show source media that may contain the product. In an embodiment, a content provider may be presented with series of drop down selection options where the content provider may select from a library of source media (e.g., television show, show season, and episode) for placement of an interactive content advertisement. In some embodiments as described herein, the placement and other information about relevant items may be known based on information (e.g., metadata) included within the source media. In some embodiments, content providers may be provided with information to assist in providing interactive content based on the metadata from the source media. In additional embodiments, a content provider may provide rules that automatically provide interactive content and related information based on the metadata, while in additional embodiments, the entire process may be completely automated based on metadata for both the source media and the interactive content.

For example, during the course of a television show, the show may display a hunting camera. In an embodiment, a content provider may want to create an interactive content package for the hunting camera in order to provide interactive content at the time the camera is displayed during the show. In the embodiment shown in FIG. 3A, the content provider may select the show, season and episode containing the camera. In exemplary embodiment, the content provider may select the manufacturer (e.g., Moultrie) and product name (e.g., M-880 Mini Game Camera) for the camera. The content provider may select a message to display for the interactive call (e.g., “Click to learn about the M-880 Mini Game Camera) that appears when the camera is displayed during playback of the media content. In an embodiment, the content provider may select a start time to display the interactive call and a length of time to display the interactive call message.

In other exemplary embodiments, the interactive call message may appear as an icon, text, picture, embedded video or other suitable interactive call. In an embodiment, the content provider may select to display the interactive call based upon selecting a timestamp of when the product displays in the media or by automatic identification of the product during playback of the source media by use of techniques such as pattern recognition or any other suitable method. In other embodiments, the content provider may be able to view the library of source media directly and select places to insert interactive call messages by clicking directly on the source media at the point the content provider wants the interactive call message displayed. In other embodiments, the content provider may be able to drag and drop interactive call messages at locations and times during playback of the source media.

FIG. 3B illustrates an exemplary non-limiting implementation of a graphical user interface for content provider interactions with an interactive content server in accordance with some embodiments of the present disclosure. In an embodiment, as shown in FIG. 3B, processing unit 200 of interactive content server 102 may execute instructions to allow content providers to manage incentives such as discounts, free shipping, and rebates, that are offered through the interactive content page.

In an exemplary embodiment, as depicted in FIG. 3B, the content provider may create a coupon for a particular product by selecting the product (e.g., Pilot Guide Jacket) through a drop down menu. The content provider may create a name and description of the coupon. The content provider may elect to enter a discount percentage that the coupon reduces the product amount by or, in an embodiment, the content provider may elect to reduce the product by a set dollar amount. The content provider may perform other actions such as to enter a budget cap for the coupon which the system will manage to assure the coupon offer is turned off at the appropriate time. In another embodiment, the content provider may enter a start time (e.g., a month, day and year) and an end time for which the coupon will be valid.

In other embodiments, the interactive content integration system may integrate with imaging editing applications (e.g., Adobe Photoshop) to allow the content provider to graphically create a coupon that is offered through the interactive content page. The interactive content server 102 may track the effectiveness of the incentive, allowing the content provider to adjust the incentive in an appropriate way to maximize user response to the product.

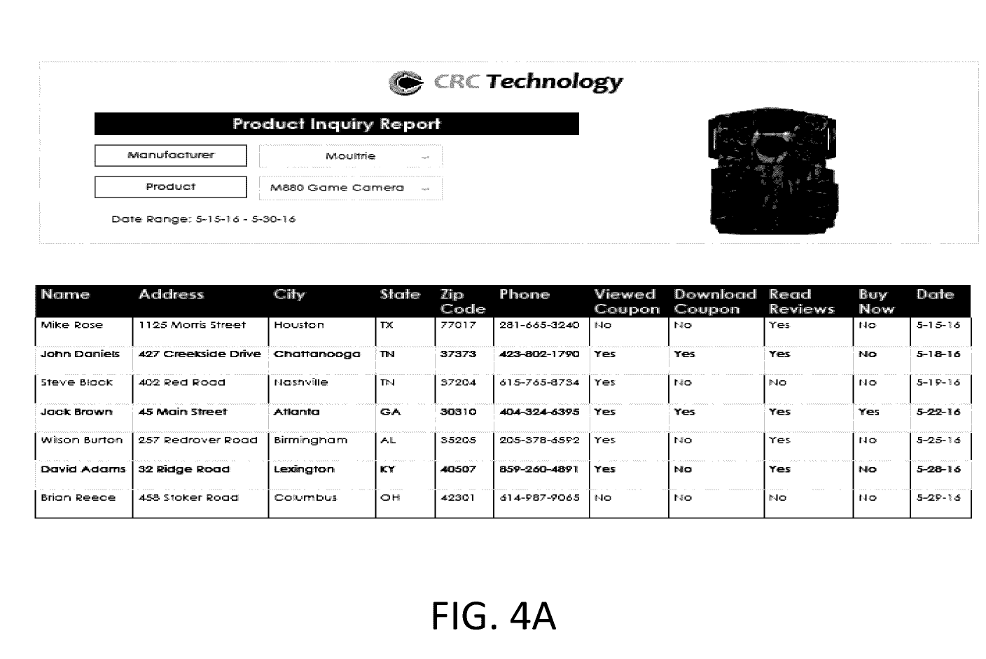

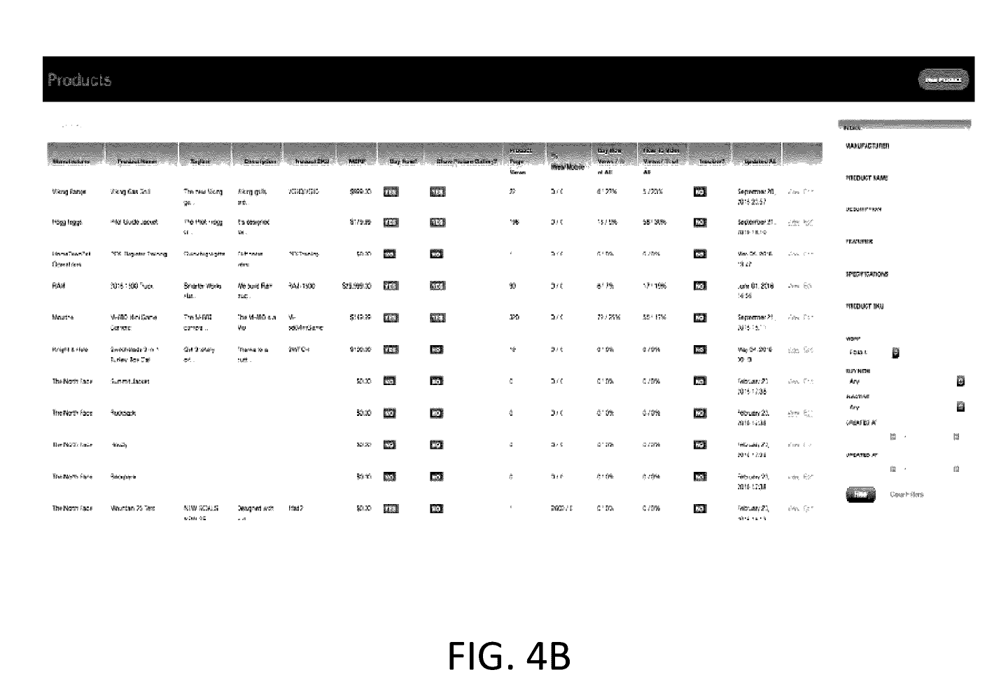

FIG. 4A illustrates additional exemplary non-limiting implementations of a graphical user interface for a user of an interactive content server in accordance with some embodiments of the present disclosure. In an embodiment, processing unit 200 of interactive content server 102 may execute instructions to allow a content provider to capture and compile a variety of data about products and users to be evaluated by the interactive content server 102 or the content provider 104. In an embodiment, information captured and stored by the interactive content server may include but is not limited to user name, user contact information (e.g., address and phone number), product viewed by the user, actions taken (e.g., whether the user viewed or downloaded a coupon, read reviews, or bought the product), and the date the user viewed the product.

The interactive content server may also capture incentive effectiveness on a user, effectiveness of a product video on user, or other relevant user information related to a particular user or interactive content. User information captured by interactive content server 102 may be stored and directly accessible via storage 216 of interactive content server 102 or may be provided (e.g., as raw data or in reports) to a content provider 104. Communication of information relating to user interaction with the interactive content may facilitate real-time data aggregation relating to users, which allows content providers to remarket products to users.

FIG. 4B illustrates additional exemplary non-limiting implementations of a graphical user interface for a user of an interactive content server in accordance with some embodiments of the present disclosure. In an embodiment, as shown in FIG. 4B, processing unit 200 of interactive content server 102 may execute instructions to allow a content provider 104 to manage their interactive content contained within the interactive content integration system. In an embodiment, as depicted in FIG. 4B, content management instructions may allow for secure access to the content provider's products so they can manage the products, including but not limited to, loading new interactive content or making updates to existing interactive content. In an embodiment as depicted in FIG. 4B, exemplary non-limiting interactive content that may be entered or updated includes manufacturer name, product name, product UPC/SKU, product overview video, how to/demo video, product images, product description, rebates/incentives, etc.

In other exemplary embodiments, a content provider may view statistics relating to a particular product, such as product page views, product “how to” video views, whether incentives have been set for the product, a date for when the product was last updated, and other functionality. The content provider may search for a particular product to edit based upon a number of factors (e.g., UPC/SKU, product name, product manufacturer, etc.). In an embodiment, the content provider may delete products that are no longer in inventory or that have been discontinued.

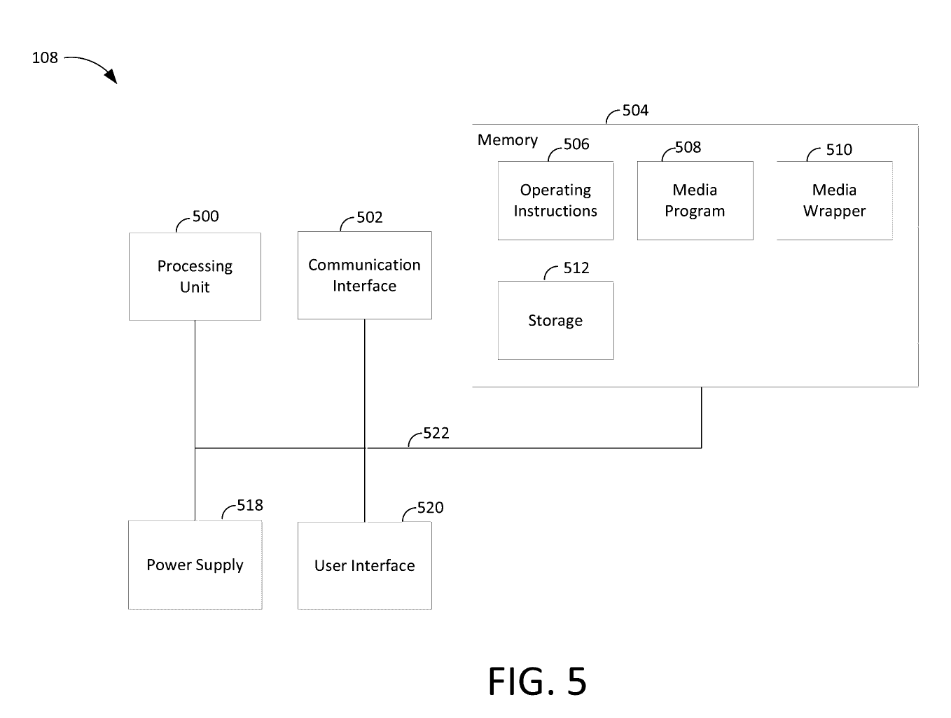

FIG. 5 depicts an illustrative block diagram of an end user device 108 in accordance with some embodiments of the present disclosure. Although particular components are depicted in a particular arrangement in FIG. 5, it will be understood that end user device 108 may include additional components, one or more of the components depicted in FIG. 5 may not be included in end user device 108, that additional components and functionality may be included within end user device 108, and that the components of end user device 108 may be rearranged in a variety of suitable manners.

In an embodiment, end user device 108 may include processing unit 500, a communication interface 502, a memory 504, a user interface 520, and a power supply 518. In embodiments where processing unit 500 includes two or more processors, the processors may operate in a parallel or distributed manner. In one embodiment, the processing unit 500 may be implemented as dual microprocessors, multi-core and other multiprocessor architectures running instructions for an operating system, programs, and applications based on processor-executable instructions that may be stored in memory 504.

Processing unit 500 may be any suitable processing element and may include hardware, software, memory, and circuitry as is necessary to perform and control the functions of end user device 108. Processing unit 500 may include one or more processors that may be configured and connected in a manner to perform the operations of end user device 108 based on instructions in any suitable number of memories and memory types. Processing unit 500 may be in communication with memory 504 (e.g., read only memory (ROM) and random access memory (RAM)) that stores data and processor-executable instructions that are executed by the processing unit 500 in order to control and perform the necessary operations of the end user device 108.

Processing unit 500 may execute an operating system of end user device 108 or software associated with other elements of end user device 108. The processing unit 500 may execute the instructions of memory 504 to interact with and control one or more other components of the end user device 108. Although the processing unit 500 may communicate with other components of the end user device 108 in any suitable manner, in one embodiment the processing unit may utilize an interface bus 522. Interface bus 522 may include one or more communication buses such as I2C, SPI, USB, UART, and GPIO. In one embodiment, the processing unit 500 may execute instructions of the memory and based on those instructions may communicate with the other components of the end user device 108 via the communication buses of interface bus 522.

The memory 504 may include any suitable memory types or combination thereof as described herein, such as flash memory and RAM memory, for storing instructions and other data generated or received by end user device 108 and providing a working memory for the execution of the operating system, programs, and applications of the end user device 108. Memory 504 may refer to suitable tangible non-transitory storage mediums for storing data, instructions, and other information, as described herein.

In embodiments, memory 504 may be configured to store information received from interactive content server 102, such as source media and interactive content packages, and other responsive information communicated in response to user interaction with interactive content. In one embodiment, the memory 504 may include operating instructions 506, media program 508, and media wrapper 510. In one embodiment, memory 504 may include one or more data stores, such as storage 512.

In an embodiment, operating instructions 506 may include instructions for interacting with interactive content server 102. An exemplary end user device 108 may communicate with interactive content server 102 (and in some embodiments, a content provider 104 or secondary media source 106) via the communication interface 502, e.g., to receive source media and information relating to interactive content to be generated as a result of selecting a product interactive call within the source media. Operating instructions 506 may include instructions that when executed by processing unit 500 control these communications and provide for secure communication, and in some embodiments, encrypt and decrypt some or all of the information communicated with the interactive content server 102 via public or private key cryptography, or other similar methods.

Exemplary operating instruction 506 may also include instructions for managing source media that may be stored in storage 512. In embodiments as described herein, storage 512 may be created and updated based on information provided to users during system operation, for example, relating to interactive content (e.g., product information, product reviews, product how to videos, etc.) based on the user viewing the interactive content. Operating instructions may provide for management of storage 512 so the interactive content is continuously stored and updated.

Media program 508 is an application that executes on end user device 108 to present information, including source media, to a user via user interface 520. The source media may be video, audio, animation, or any other type of content that the user interface 520 is able to present. In an embodiment, media program 508 may be implemented as a media player, such as Windows Media Player, YouTube, Apple TELEVISION, Hula, or any suitable platform for displaying source media. In an embodiment, media program 508 is operable to host interactive content. Media program 508 manages the manner (e.g., timing and location) in which the interactive content is presented using the media wrapper 510.

Media wrapper 510 may include instructions that utilize the received interactive content package for creating an overlay of interactive calls and interactive content within the content playing on the media program 508. The media wrapper may function with a media program in a variety of manners, for example, the media wrapper may be embedded within a media program (e.g., as software within a set-top box, video player, audio player, etc.), or in some embodiments, the media wrapper 510 may comprise a media player plug-in that interacts with a media program. Media wrapper 510 may place interactive content interactive calls by wrapping the pre-existing source media and superimposing interactive content interactive calls onto the pre-existing source media by communicating with the interactive content server to obtain an interactive content package (e.g., interactive call messaging, time code to insert interactive call messaging, how long the interactive call is displayed, link to interactive content page, etc.) relating to the source media. In an embodiment, the interactive content package may be requested based on a unique identifier provided by the source content, which the media wrapper then communicates to the interactive content server to request the interactive content package. In an embodiment, media wrapper 510 may cause media player 508 to display a modified version of source media based on the received interactive content package.

In an embodiment, media wrapper 510 may include instructions displaying the interactive call on the source media and for stopping the source media playing on media program 508 when a user selects an interactive call displayed on the source media. The media wrapper 510 may access interactive content based on interactive content provided in the interactive content package and by communicating with interactive content server 102 and/or a content provider 104. The media wrapper 510 may display the interactive content within the media player, in another window, or in other suitable manners as are available based on the user interface of the user device. The media wrapper 510 may cause user device 108 to communicate user interactions to the interactive content server 102 and/or content provider 104. In an embodiment, the media wrapper 510 may resume playback of the source media at the point where the user selected the interactive call once the user exits interaction with the interactive content.

The end user device 108 may include one or more source media repositories, illustrated as storage 512. The storage 512 may be a content repository in which source media, interactive content, and other related information may be stored. In an embodiment, source media and interactive content may be transferred from interactive content server 102 over the network 106 to the storage 512 via communication interface 502. In one embodiment, the interactive content server 102 delivers the source media to the end user device 108, which is configured to play the source media on a media player 508. In other embodiments, the interactive content server 102 may deliver the source media by streaming the source media to the end user device 108.

Communication interface 502 may include components and/or a device that allows end user device 108 to communicate with another device, such as interactive content server 102, via a public or dedicated communication network (e.g., the network 106). In embodiments, communication interface 502 may establish a secured connection with the interactive content server 102 and may be configured to send receive information, such as source media, an interactive content package, interactive content, user interactions, and other related information. Communication interface 502 may include one or more wireless transceivers for performing wireless communication and/or one or more communication ports for performing wired communication.

User interface 520 may provide various options that allow a user to interact with applications and programs running on end user device 108. In an embodiment, interactions may be performed via user interface 520 which may provide a device (e.g., a display, keyboard, mouse, hand held control device, etc.) with options for interacting with the end user device 108. In some embodiments, interaction may be performed remotely, for example, via communication interface 502. While one user interface 520 is shown, an example user interface 520 may include hardware and software for any suitable user interface.

End user device 108 may also include a power supply 518. Power supply 518 may supply a variety of voltages to the components of the end user device 108 in accordance with the requirements of those components. Power supply 518 may include power conversion circuitry for converting AC power and/or generating a plurality of DC voltages for use by components of the end user device 108. In some embodiments, power supply 518 may include a backup system such as a battery backup, to avoid interruptions in service during power outages.

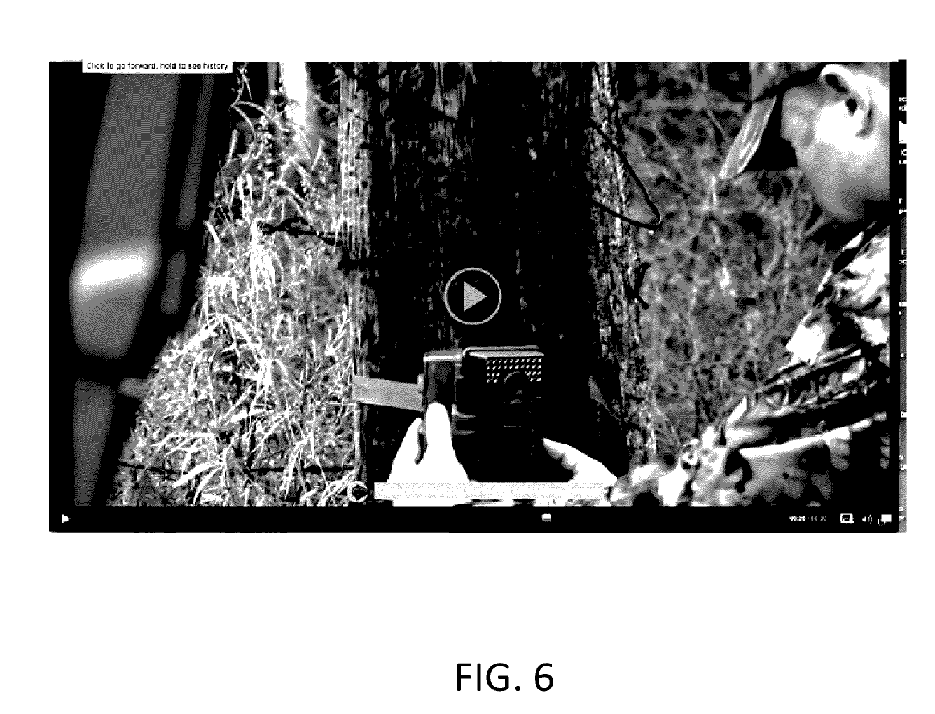

FIG. 6 illustrates exemplary non-limiting implementations of a graphical user interface at an end user device in accordance with some embodiments of the present disclosure. In an embodiment, as shown in FIG. 6, processing unit 200 of end user device 108 may execute media program 508 and media wrapper 510 to allow a user to view source content (e.g., a video file) and interactive content. In an exemplary embodiment, a scene in a video is being displayed. In the scene, a person is using a product, such as a camera (e.g., the M-880 Mini Game Camera). If a content provider has elected to post an interactive call for the camera at this point in time in video, an interactive call in the form of a logo, text, or other form of advertisement for the camera, may be graphically displayed (e.g., superimposed or overlaid) below the camera, based on settings (e.g., manner of display, color, effects, etc.).

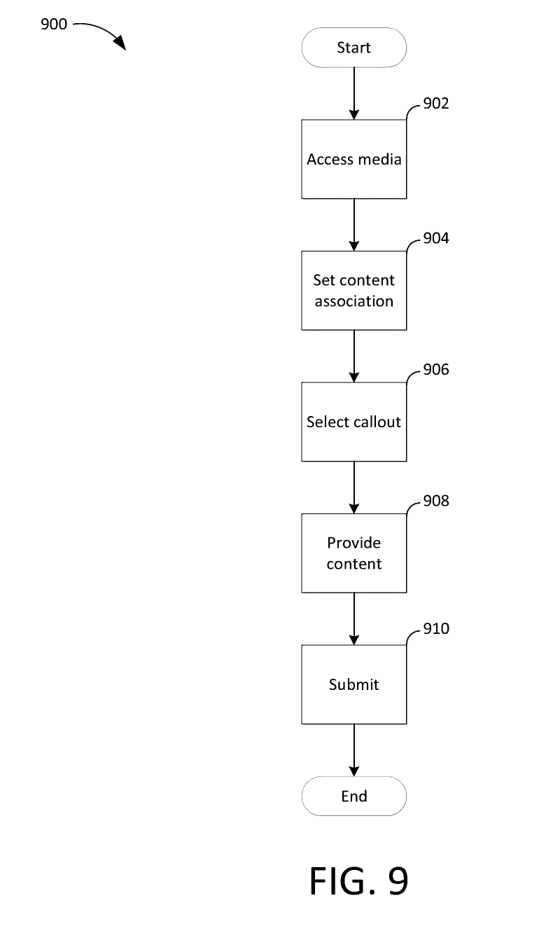

The process of applying, or superimposing, the interactive call is discussed in further detail with regard to the description of FIG. 9. In an embodiment, interactive calls may be applied to any type of media content (e.g., live video, taped video, streaming media, audio, OTT video platforms, etc.). In an embodiment, as shown in FIG. 6, interactive calls may be interactive which may allow for overlay of the interactive call, which may pause the video and navigate the user to interactive content (e.g., webpages) where the user may interact with useful information about a product, and in some embodiments, engage in product purchases.

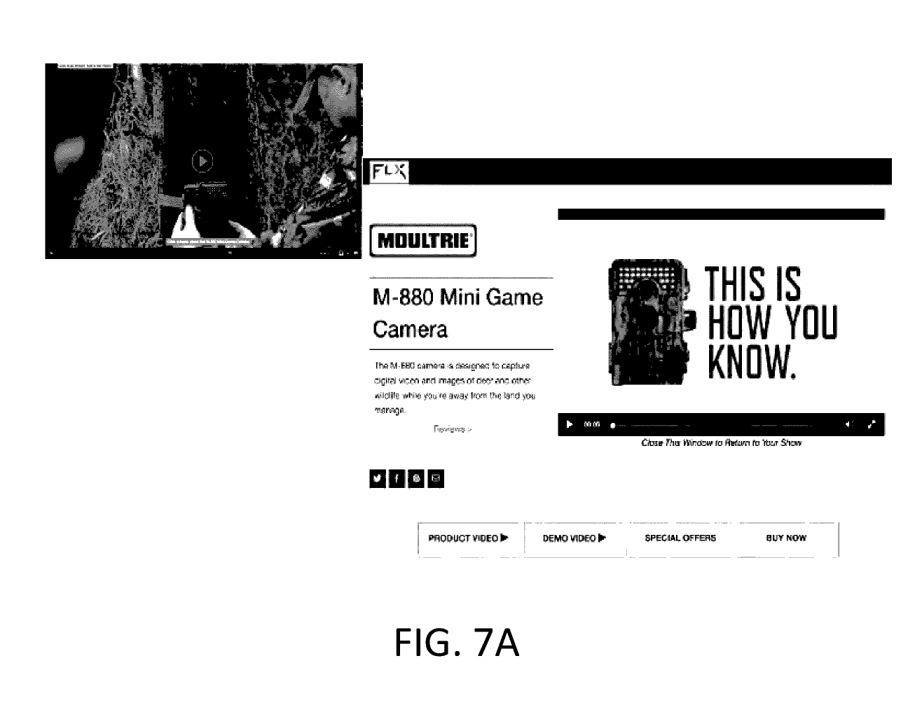

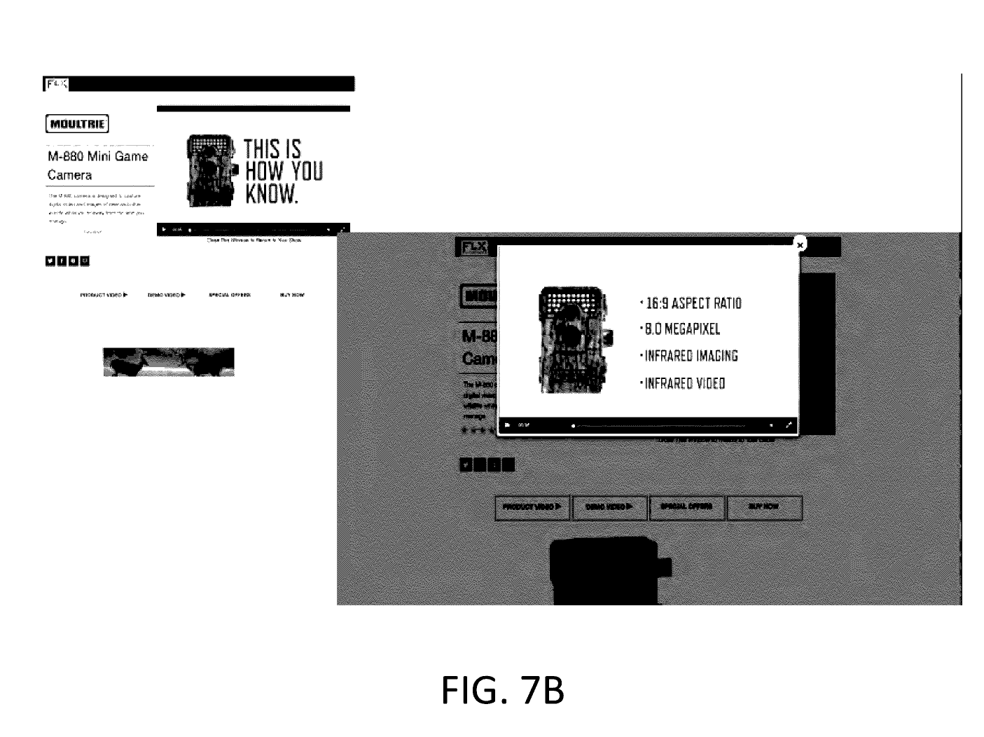

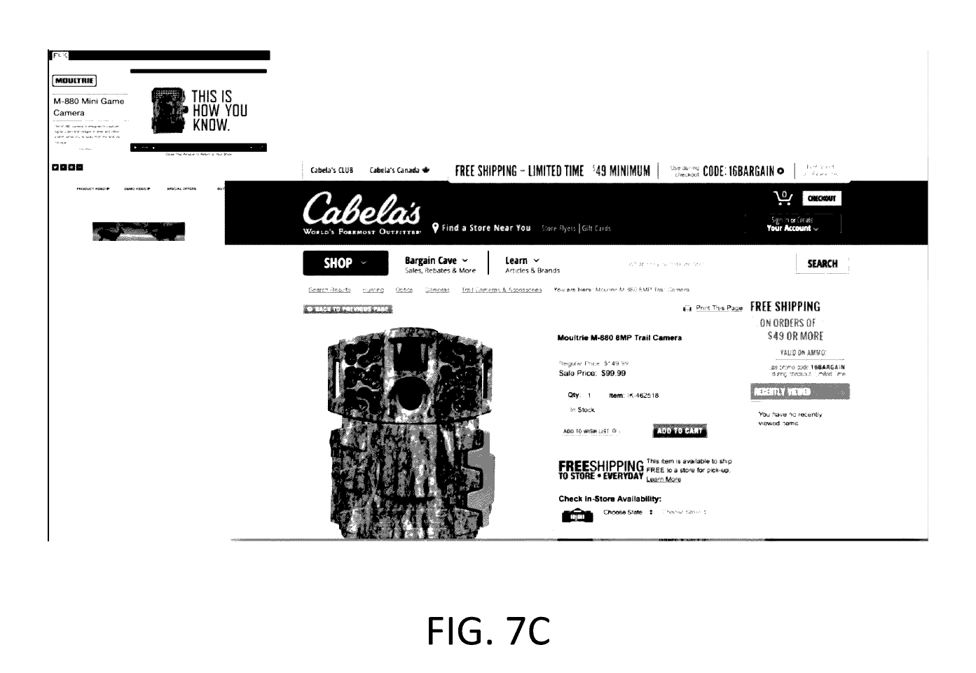

FIGS. 7A-7C illustrate exemplary non-limiting implementations of a graphical user interface at an end user device after a selection of interactive content by a user in accordance with some embodiments of the present disclosure. In an embodiment, as previously discussed in FIG. 6, a user is watching a video which has displayed interactive content (e.g., “Click to learn about the M-880 Mini Game Camera”) relating to a product (e.g., the Mini Game Camera) being displayed in the video. As depicted in FIG. 7A, the user elected to select an interactive call to access the interactive content for the product. In an embodiment, activation of the interactive call may occur in several ways, including but not limited to, using control buttons on hand-held control device (e.g., a remote control), using a wired or wireless mouse, using a touch-screen interface or any other suitable selection method.

In the embodiment of FIG. 7A, once activated the interactive call may pause the video and display an interactive content page in a border window. As shown in FIG. 7A, the original video may remain viewable in a window adjacent to the interactive content page. In an embodiment, information displayed on the interactive content page may include a product video, demo video, special offers for purchase of the product, options to buy the product, product reviews, or other information. In an embodiment, as depicted in FIG. 7B, the user has chosen to watch the product video, which may include an interactive video displaying information about the product, including product specifications, warranties, product features, or other suitable information. In an embodiment, the user may elect to save the product video (e.g., in storage 512) for later viewing.

In an embodiment, as depicted in FIG. 7C, the user has chosen to “Buy Now” option from the interactive content page. By selecting the “Buy Now” option, the user is linked to the content provider home page, approved retailer, or product company website where the user may make a purchase of the product. For example, as depicted in FIG. 7C, the “Cabela's” website may be a special website designed specifically for the user to purchase the “M-880 8MP Trail Camera.” In other embodiments, information displayed on the interactive content page may link the user to the home page of the manufacturers the product or to an address and phone number of a local content provider who sells the product. In an embodiment, if the content provider is national, additional information may link the user to local distributors or franchises.

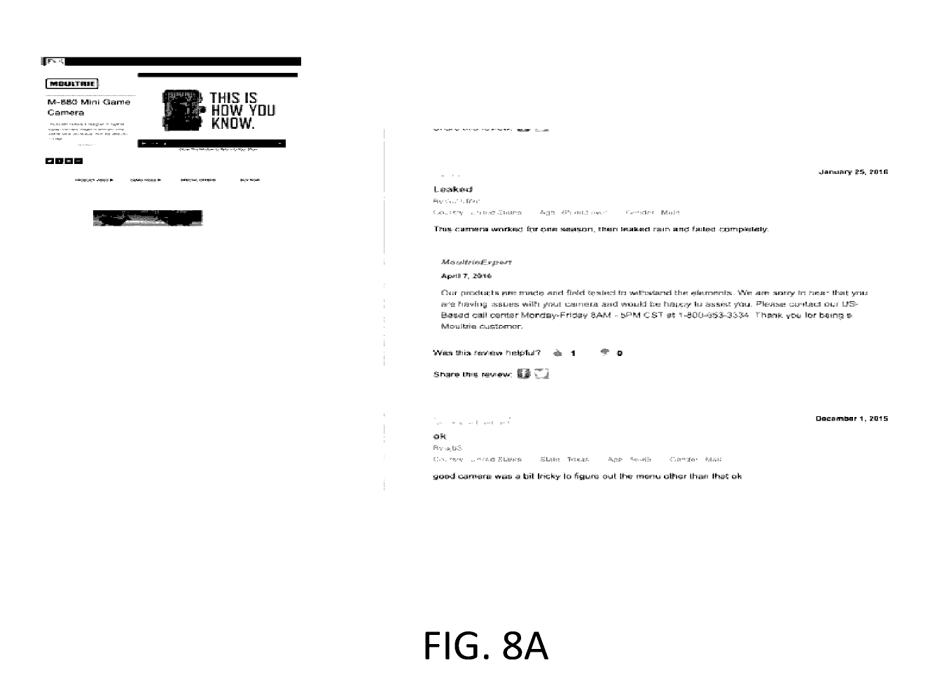

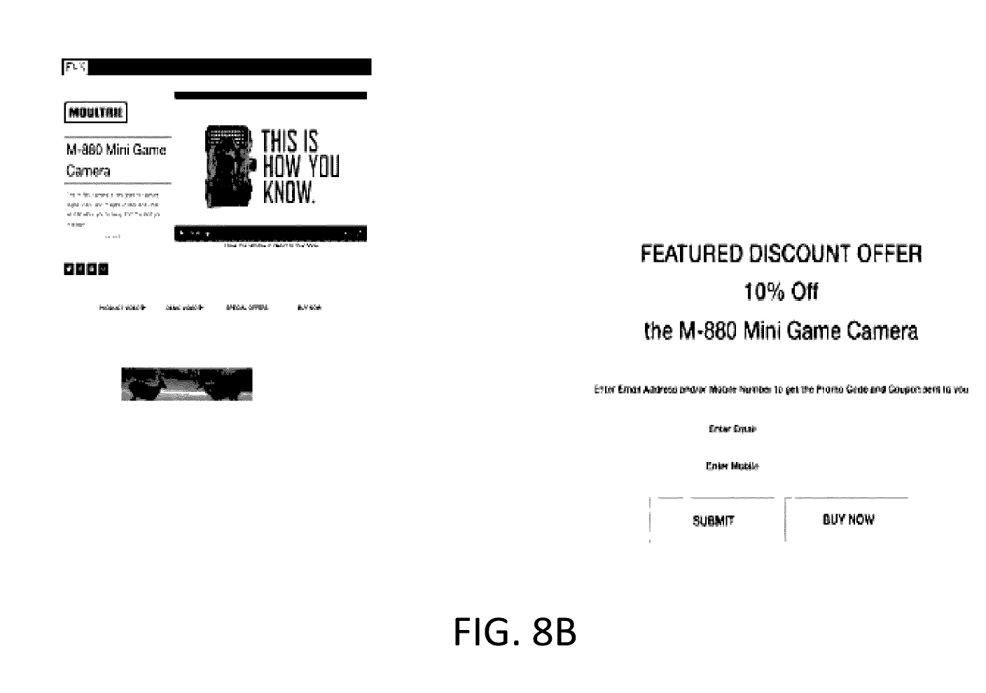

FIG. 8A-8B illustrate additional exemplary non-limiting implementations of a graphical user interface at a user device after a selection of interactive content by a user in accordance with some embodiments of the present disclosure. In an embodiment, as depicted in FIG. 8A, the user has elected (e.g., via the interactive content page) to view product reviews from other users. In an embodiment, the user may sort reviews based upon a star rating. For example, the user may only choose to display reviews from other users who rated the product 5 stars. User reviews may be sorted by other methods (e.g., by review date, purchase date, etc.) and the user may write his/her own review if the user has purchased and used the product. The user may write a comment or question beneath the review of another user, which may ping the other user for a response

In an embodiment, as depicted in FIG. 8B, the user has selected the “Special Offers” option from the interactive content page. By selecting the “Special Offers” option, another page is displayed which provides information regarding incentives for purchase of the product. For example, the user may enter the user's email or phone number to receive a 10% percent off coupon. The incentive may be in the form of a percentage discount, a reduction in price if the user purchases the product in combination with another product, a volume discount for purchase of the product, or any suitable incentive deemed appropriate by the content provider. The user may also select the “Buy Now” option from the incentive, which may navigate the user to content provider page to purchase the product. The user may elect to download the coupon on the end user device, such as a mobile phone or tablet, for later use. In an embodiment, the user may choose to visit the store in person and show the downloaded coupon for purchase of the product.

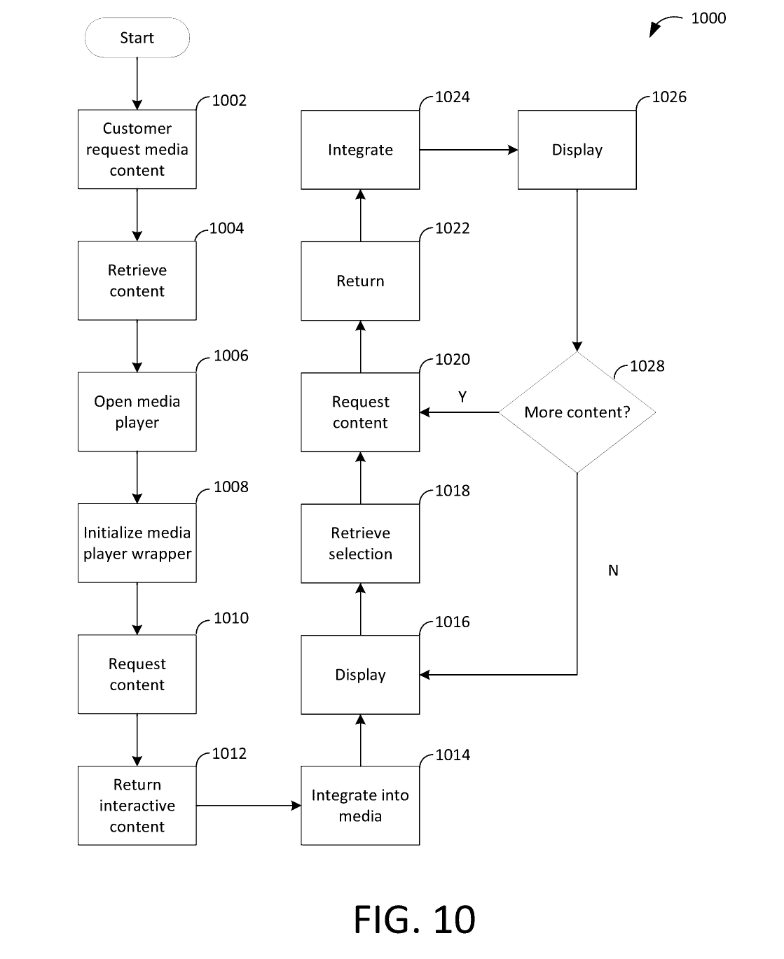

In view of the structures and devices described supra, methods that can be implemented in accordance with the disclosed subject matter will be better appreciated with reference to the flowcharts of FIGS. 9-10. Although steps may be depicted in a particular flow and order, it will be understood that the flow may be modified consistent with the disclosure provided herein, that steps may be removed, and that additional steps may be added consistent with the present disclosure.

FIG. 9 depicts exemplary steps for creating integrated media content in accordance with some embodiments of the present disclosure.

At step 902, a content provider may access particular source media (e.g., television show, movie, video, etc.) for which the content provider may want to apply interactive content. The content provider 104 accesses the interactive content server 102 to apply one or more interactive calls to source media, which may be stored in storage 216 of interactive content server 102. Processing may then continue to step 904.

At step 904, a content provider may set source media associations for products displayed in the source media. The content provider 104 accesses the interactive content server 102 to apply one or more interactive calls to source media, which may be stored in storage 216 of interactive content server 102. Processing unit 200 may execute instructions in memory 204, such as media management instructions 208 which may allow the content provider to set source media associations for products displayed in the source media. As described herein with respect to FIG. 2, media management instructions 208 may allow a content provider to manage the placement of interactive content within source media, such as selecting the source media to apply the interactive call, associating one or more products with the source media, creating interactive call message, designating places within the source media for displaying the interactive call, designating how long to display the interactive call and other functionality. Processing may then continue to step 906.

At step 906, a content provider may select an interactive call to display within the source media. The content provider 104 accesses the interactive content server 102 to apply one or more interactive calls to media content, which may be stored in storage 216 of interactive content server 102. Once the content provider has completed selecting an interactive call, processing may continue to step 908.

At step 908, a content provider may select interactive content linked to the interactive call and the source media. As described herein with respect to FIG. 2, content management instructions 210 may allow a content provider 110 to manage their interactive content contained within the interactive content integration system. In an embodiment, content management instructions may allow for secure access to the content provider's products so they can provide interactive content related to the products, including but not limited to, loading new interactive content or making updates to existing interactive content. In an embodiment, exemplary non-limiting interactive content that may be entered or updated includes product name, product UPC/SKU, product overview video, how to/demo video, product images, product description, rebates/incentives, etc. Processing may then continue to step 910.

At step 910, the content provider may submit the associated content and interactive content integration system may generate an interactive content package based on the entered settings, and in some embodiments, a unique identifier may be associated with the interactive content package. The interactive content package may then be supplied to users on request as described herein, for example, with requested source media or in response to an identifier provided by a user device. The processing of the steps of FIG. 9 may then end.

FIG. 10 depicts exemplary steps for displaying integrated media content in accordance with some embodiments of the present disclosure.

At step 1002, a user may request source media. End user device 108 may interact with interactive content server 102 to request source media, or example based on a user attempting to access particular source media based on selection with a media program. Processing may then continue to step 1004.

At step 1004, the system may retrieve the source media. Interactive content server may retrieve source media from storage 216. The source media may be transferred from interactive content server 102 over the network 106 to the storage 512 via communication interface 502. In an embodiment, the interactive content server 102 may deliver the source media by streaming the source media to the end user device 108. Processing may then continue to step 1006.

At step 1006, the media program may initialize in order to play the source media. Processing may then continue to step 1008, at which time the media wrapper program is initialized (e.g., as a call in software for an integrated media wrapper, or by initializing a media wrapper plug-in). The media wrapper program may begin communication with the interactive content server, and in an embodiment, may access an identifier within the source media (e.g., identifying a source media file or interactive content to provide for the source media). Processing may then continue to step 1010.

At step 1010, media wrapper 510 may request an interactive content package from interactive server 102. As described herein, in some embodiments the interactive content package may be requested based on the unique identifier. Processing may then continue to step 1012.

At step 1012, interactive content server may return the interactive content package to the media program wrapper 510 which may include associated content relating to the source media as discussed herein (e.g., interactive call messaging, designation of when to insert interactive call messaging, how long to display the interactive call, link to access interactive content page, interactive media, etc.). Processing may then continue to step 1014.

At step 1014, the media wrapper 510 may integrate information from the interactive content package into the source media. As discussed herein, media wrapper 10 may place interactive calls within the source media (e.g., by superimposing over the source media or modifying the underlying source media) based on settings of the interactive content package (e.g., location, time, appearance, content, effects, etc.). Processing may then continue to step 1016.

At step 1016, the source media and interactive call are displayed to the user via the media program 508 and based on the media wrapper 510. Processing may then continue to step 1016. At step 1018, the user may choose to select the interactive call while viewing the source media. As described herein, activation of the interactive call may occur in several ways, including but not limited to, using control buttons on hand-held control device (e.g., a remote control), using a wired or wireless mouse, using a touch-screen interface or any other suitable selection method. Processing may then continue to step 1020.

At step 1020, the media wrapper 510 may request the interactive content upon the user selecting the interactive call. In some embodiments, the interactive content may already be available at the user device from the interactive content package, while in other embodiments the interactive content may be requested (e.g., from the interactive content server). Processing may then continue to step 1022.

At step 1022, the interactive content is returned (e.g., accessed from the interactive content package or received from the interactive content server 102 in response to a request). Processing may then continue to step 1024.

At step 1024, the media wrapper integrates the interactive content into the source media. Processing may then continue to step 1026. At step 1026, once the interactive content is integrated, media wrapper 510 may cause the media program 508 to display the interactive content. In an embodiment, information displayed on the interactive content page may include product associations (e.g., a product video, demo video, special offers for purchase of the product, options to buy the product, product reviews, or other information). Processing may then continue to step 1028.

At step 1028, the media wrapper may determine whether the user wants to view additional interactive content based on user interactions with the interactive content. For example, in an embodiment, the user may want to view a demo video contained within an interactive content page. If the user elects to view more associated content, processing returns to step 1020 at which the additional interactive content is provided. If the user is finished viewing the interactive content, processing returns to step 1016 and the source media begins playing at the point where the user selected the interactive content.

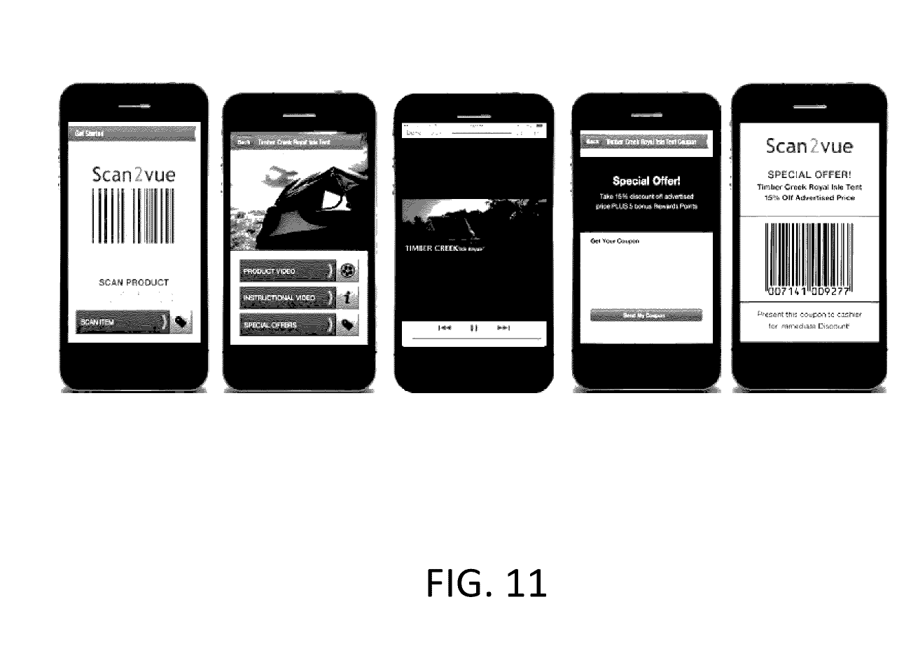

FIG. 11 illustrates exemplary non-limiting implementations of a graphical user interface for an interactive content integration system in an in-store retail application in accordance with some embodiments of the present disclosure. In an embodiment, the in-store application may access source media that is customized by a content provider, with interactive content provided and accessed as described herein.

In an embodiment, as shown in the far left screen shot of FIG. 11, a user may use a device, such as a smart phone equipped with a camera, to scan the UPC code on a product while shopping in-store to learn more about the product. In an embodiment, as depicted in the second screen shot from the left, once the user scans the UPC, an interactive content page may be displayed on the screen of the end user device (e.g., a mobile smart phone). In an embodiment, the interactive content page may function in a similar manner as described herein and allow the user to navigate to other content pages where the user may view product videos, demo videos, product incentives or other functionality as depicted the last three screen shots of FIG. 11.

In other embodiments, the user may take a picture of the product while in-store shopping. In an embodiment, the interactive content integration system may recognize the product through image recognition techniques and navigate the user to the interactive content based upon automatic recognition of the image. In another embodiment, the interactive content integration system may use voice recognition techniques to allow the user to speak the name of the product into the user device by use of the user interface of the user device (e.g., audio microphone). The name of the product may be recognized relevant interactive content may be provided to the user.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

As a further example, variations of apparatus or process parameters (e.g., dimensions, configurations, components, process step order, etc.) may be made to further optimize the provided structures, devices and methods, as shown and described herein. In any event, the structures and devices, as well as the associated methods, described herein have many applications. Therefore, the disclosed subject matter should not be limited to any single embodiment described herein, but rather should be construed in breadth and scope in accordance with the appended claims.

What is claimed is:

1. A system for providing interactive media content to a user, comprising:
a user interface;
a communication interface;
a processor coupled the communication interface to exchange information with one or more external servers, and to the user interface to provide source media and interactive content to a user and to receive user inputs, the processor configured to execute instructions;
a memory having the instructions stored thereon and coupled to the processor to provide the instructions to the processor, wherein when executed by the processor the instructions cause the processor to:
receive the source media via the communication interface;
receive the interactive content package via the communication interface;
display the source media via the user interface;
display an interactive call within the source media via the user interface, wherein the display of the interactive call is based on information provided in the interactive content package;
receive a first user input to select the interactive call via the user interface; and
display interactive content in response to the interactive call, wherein the interactive content is related to the source media.

2. The system of claim 1, wherein the instructions further cause the processor to launch a media program and a media wrapper, wherein the media program causes the display of the source media and the media wrapper causes the display of the interactive call and the interactive content.

3. The system of claim 2, wherein the media program comprises a media player.

4. The system of claim 3, wherein the media wrapper comprises a media player plug-in.

5. The system of claim 1, wherein the display of the interactive call within the source media comprises an overlay of the interactive call over the source media.

6. The system of claim 1, wherein the display of the interactive call within the source media comprises a modification of the source media to embed the interactive call in the source media file.

7. The system of claim 1, wherein the information provided in the interactive content package comprises the content of the interactive call, the location of the interactive call, and a time period for display of the interactive call.

8. The system of claim 7, wherein the content of the interactive call comprises text, an icon, or an embedded video.

9. The system of claim 7, wherein the location of the interactive call comprises a variable location based on the location of an associated item within the source media.

10. The system of claim 7, wherein the information provided in the interactive content package further comprises a display effect for the interactive call.

11. The system of claim 1, wherein the instructions further cause the processor to:
determine a unique identifier associated with the source media;
request the interactive content package from the one or more external servers based on the unique identifier via the communication interface; and
receive the interactive content package from the one or more external servers based on the request.

12. The system of claim 11, wherein the unique identifier is unique to the source media.

13. The system of claim 11, wherein the unique identifier is unique to the interactive content package.

14. The system of claim 1, wherein the one or more external servers comprise an interactive content server and a content provider server, wherein the source media is received from the content provider server, and wherein the interactive content package is received from the interactive content server.

15. The system of claim 1, wherein the one or more external servers comprise an interactive content server and a secondary media server, wherein the source media is received from the secondary media server, and wherein the interactive content package is received from the interactive content server.

16. The system of claim 1, wherein the instructions further cause the processor to:
receive second user inputs related to the interactive content via the user interface;
request responsive media based on the second user inputs via the communication interface;
receive the responsive media via the communication interface; and
display the responsive media via the user interface.

17. The system of claim 1, wherein the instructions further cause the processor to:
receive second user inputs related to the interactive content via the user interface; and
transmit information regarding the first user input and second user inputs to the one or more external servers.

18. The system of claim 1, wherein the interactive content relates to an item displayed within the source media, and wherein the interactive content comprises an instructional video for the item, purchase information for item, or reviews for the item.

19. The system of claim 1, wherein the information provided within the interactive content package further comprises the interactive content.

20. A method for providing interactive media content to a user, comprising:
receiving source media via a user interface of a user device;
receiving an interactive content package via a communication interface of the user device;
displaying the source media via the user interface;
displaying an interactive call within the source media via the user interface, wherein the display of the interactive call is based on information provided in the interactive content package;
receiving a first user input to select the interactive call via the user interface; and
displaying interactive content via the user interface in response to the interactive call, wherein the interactive content is related to the source media.

21. A tangible non-transitory computer readable medium having instructions stored thereon, that when executed by a processor cause the processor to perform steps comprising:
receiving source media via a user interface of a user device;
receiving an interactive content package via a communication interface of the user device;
causing display of the source media via the user interface;
causing display of an interactive call within the source media via the user interface, wherein the display of the interactive call is based on information provided in the interactive content package;
receiving a first user input to select the interactive call via the user interface; and
causing display of interactive content via the user interface in response to the interactive call, wherein the interactive content is related to the source media.
